(19) United States
(12) Patent Application Publication
(10) Pub. No.: US 2026/0137234 A1
(43) Pub. Date: May 21, 2026

(54) GRIDDLE COVER

(71) Applicant: Xiaoyang Yu, Yueyang (CN)

(72) Inventor: Xiaoyang Yu, Yueyang (CN)

(21) Appl. No.: 18/948,924

(22) Filed: Nov. 15, 2024

(51) Int. Cl. A47J 36/06; A47J 37/07

(52) U.S. Cl. CPC A47J 36/06; A47J 37/0786

(57) ABSTRACT

The disclosure discloses a griddle cover, which includes a bottom plate, where a first side plate and a third side plate are formed on front and rear sides of the bottom plate respectively, and a second side plate and a fourth side plate are formed on left and right sides of the bottom plate respectively; edges of the first side plate, the second side plate, the third side plate and the fourth side plate are folded outward to form clamping grooves to be connected with edges of the griddle; and the griddle cover is provided with a plurality of magnets to be attracted to the griddle. The griddle cover can completely cover the surface and side surface edges of the griddle to prevent rainwater and dust from entering. The magnets are completely wrapped in silica gel to avoid falling and prevent rusting.

### TECHNICAL FIELD

The disclosure herein relates to the field of design of griddle covers, and in particular, to a griddle cover.

### BACKGROUND

A griddle cover is used for covering a griddle, and has a protection function. However, an existing griddle cover is very simple, and is just put on a bottom plate of the griddle, so the griddle cover can only simply cover the griddle without covering edges of the griddle, rainwater and dust may enter from side surface edges of the griddle, and when the griddle cover is put into the griddle, it is not easy to take out, cannot be tightly attached to a surface of the griddle, and is easy to move or be blown away by the wind, which is very inconvenient to use.

### SUMMARY

An objective of the disclosure is to provide a griddle cover for solving the above problem.

The disclosure realizes the above objective through the following technical solution:

A griddle cover, which includes a bottom plate. A first side plate and a third side plate are formed on front and rear sides of the bottom plate respectively, and a second side plate and a fourth side plate are formed on left and right sides of the bottom plate respectively. The first side plate, the second side plate, the third side plate, and the fourth side plate are sequentially connected along a circumferential direction.

Edges of the first side plate, the second side plate, the third side plate, and the fourth side plate are folded outward to form clamping grooves to be connected with edges of the griddle.

The griddle cover is further provided with a plurality of magnets to be attracted and connected to the griddle.

In some implementations, the griddle cover is integrally formed by silica gel, and the magnets are wrapped in the silica gel.

In some implementations, the magnets are fixedly formed on the bottom plate.

In some implementations, the magnets are sequentially arranged along the circumferential direction of the bottom plate.

In some implementations, the magnets are fixedly formed on the first side plate, the second side plate, the third side plate, and the fourth side plate.

In some implementations, the magnets are arranged on the bottom plate, the first side plate, the second side plate, the third side plate, and the fourth side plate respectively.

In some implementations, the magnets are circular, oval, or polygonal.

In some implementations, arc-shaped handles with holes are formed on the second side plate and the fourth side plate.

In some implementations, the bottom plate is provided with a plurality of raised stripes arranged in parallel.

In some implementations, heights of the first side plate, the second side plate, and the fourth side plate are greater than that of the third side plate, and a joint between the third side plate and each of the second side plate and the fourth side plate is smoothly transitioned.

In some implementations, the second side plate and the third side plate both includes a straight section and an arc section, and the straight section and the arc section are in smooth transition connection.

The beneficial effects are as follows:
1. The griddle cover provided by the disclosure can be tightly attached to a surface of the griddle, and connected with the griddle through the clamping grooves formed by folding the edges of the side plates, such that the griddle cover can completely cover the surface and side surface edges of the griddle to prevent rainwater and dust from entering.
2. The magnets that are integrally built in are completely wrapped in the silica gel to avoid falling and prevent pollution caused by rusting.

### BRIEF DESCRIPTION OF FIGURES

To describe the technical solutions in embodiments of the disclosure or the prior art more clearly, the following briefly describes the accompanying drawings required for describing the embodiments or the prior art. Apparently, the accompanying drawings in the following description show only some embodiments of the disclosure, and a person of ordinary skill in the art may still derive other accompanying drawings from the accompanying drawings without creative efforts.

FIG. 1 is a three-dimensional diagram of a griddle cover according to the disclosure;

FIG. 2 is a three-dimensional diagram showing cooperation between a griddle cover and a griddle according to the disclosure;

FIG. 3 is a bottom view of a griddle cover according to the disclosure;

FIG. 4 is a three-dimensional diagram of another implementation of a griddle cover according to the disclosure;

FIG. 5 is a left view of another implementation of a griddle cover according to the disclosure;

FIG. 6 is a three-dimensional diagram of another implementation of a griddle cover according to the disclosure in an upward direction;

FIG. 7 is a structural enlarged view of portion A in FIG. 6; and

FIG. 8 is an exploded view showing cooperation between another implementation of a griddle cover and a griddle according to the disclosure.

Reference numerals are as follows:

1, first side plate; 2, second side plate; 201, straight section; 202, arc section; 3, third side plate; 4, fourth side plate; 5, bottom plate; 6, magnet; 7, clamping groove; 8, handle; and 9, griddle.

### DETAILED DESCRIPTION

In order to make objectives, technical solutions, and advantages of the disclosure clearer, the technical solution of the disclosure will be further described in detail below. Apparently, the described embodiments are merely a part of embodiments of the disclosure and are not all the embodiments. On the basis of the embodiments in the disclosure, all other implementations obtained by a person of ordinary skill in the art without creative efforts fall into the scope of protection of the disclosure.

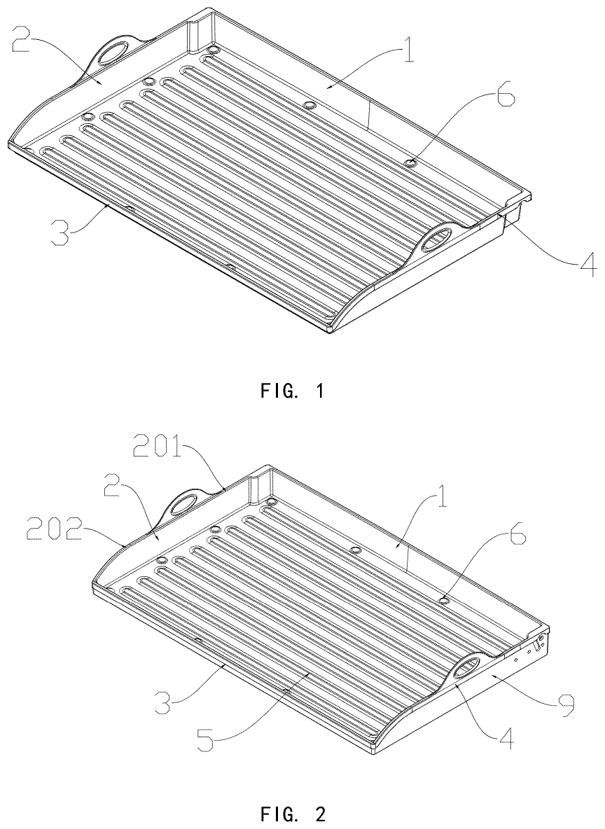

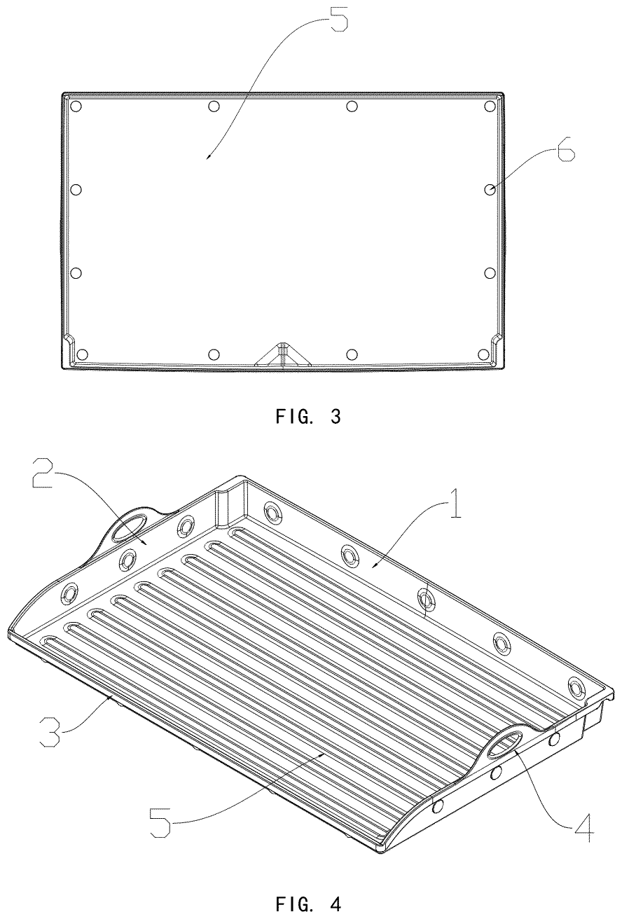

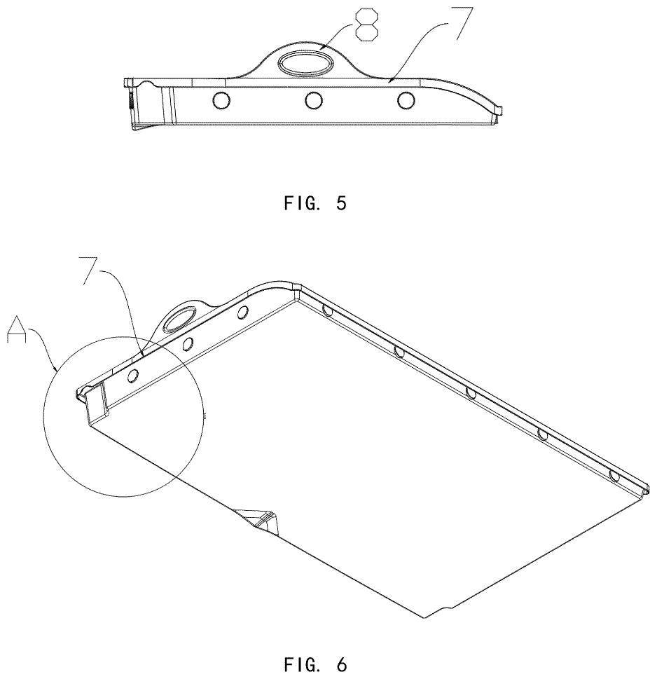

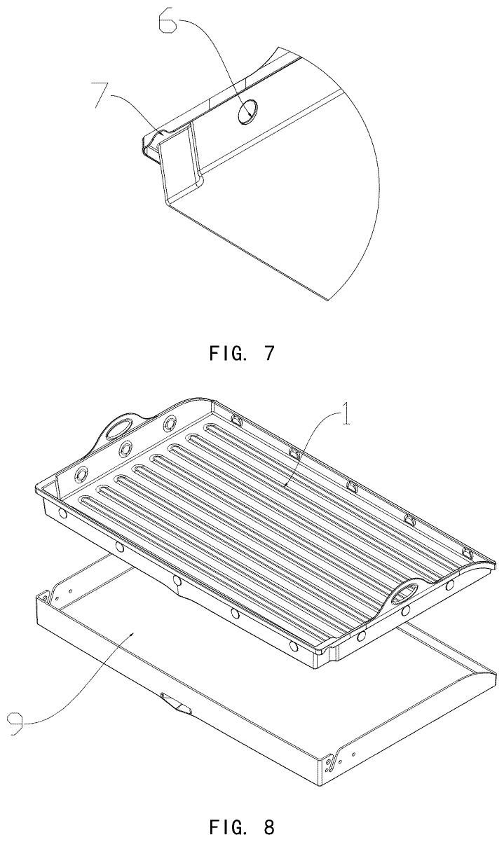

As shown in FIG. 1 to FIG. 8, the disclosure provides a griddle cover, which includes a bottom plate 5. A first side plate 1 and a third side plate 3 are formed on front and rear sides of the bottom plate 5 respectively, and a second side plate 2 and a fourth side plate 4 are formed on left and right sides of the bottom plate 5 respectively. The first side plate 1, the second side plate 2, the third side plate 3, and the fourth side plate 4 are sequentially connected along a circumferential direction. Edges of the first side plate 1, the second side plate 2, the third side plate 3, and the fourth side plate 4 are folded outward to form clamping grooves 7 to be connected with edges of the griddle 9. As shown in FIG. 6 and FIG. 7, by clamping the edges of the griddle 9 through the clamping grooves 7, the edges of the griddle 9 can be completely covered, so as to prevent rainwater and dust from entering the griddle 9 from side surface edges.

As an important implementation of the present solution, the griddle 9 cover is further provided with a plurality of magnets 6 to be attracted and connected to the griddle 9. The griddle 9 cover is integrally formed by silica gel, and the magnets 6 are wrapped in the silica gel. The magnets 6 are integrally built in the griddle 9 cover, such that the magnets 6 has strong magnetic performance and good effect, and are completely wrapped in the silica gel, which can avoid falling and prevent pollution caused by rusting.

As shown in FIG. 1 to FIG. 3, in some implementations, the magnets 6 are fixedly formed on the bottom plate 5.

Specifically, the magnets 6 are sequentially arranged along the circumferential direction of the bottom plate 5. The griddle 9 cover can be prevented from moving, falling, or being blown away by the wind through tight attachment and attraction between the magnets 6 and the bottom of the griddle 9.

As shown in FIG. 4 to FIG. 8, in some implementations, the magnets 6 are fixedly formed on the first side plate 1, the second side plate 2, the third side plate 3, and the fourth side plate 4. The side plates are connected with side surfaces of the griddle 9 through the magnets 6, so as to prevent the griddle 9 cover from moving. The magnets 6 are arranged on the side plates. When the griddle 9 cover is separated from the griddle 9, the magnets 6 slide outward along inner walls of the griddle 9 to facilitate the separation of the griddle 9 cover and the griddle 9.

In some implementations, the magnets 6 are arranged on the bottom plate 5, the first side plate 1, the second side plate 2, the third side plate 3, and the fourth side plate 4 respectively.

Furthermore, the magnets 6 are circular, oval, or polygonal.

As shown in FIG. 1, arc-shaped handles 8 with holes are formed on the second side plate 2 and the fourth side plate 4. The handles 8 on the two sides are used for accommodating and unloading the silica gel cover, and can be further used for hanging, which is convenient to use.

In some implementations, the bottom plate 5 is provided with a plurality of raised stripes arranged in parallel.

In some implementations, heights of the first side plate 1, the second side plate 2, and the fourth side plate 4 are greater than that of the third side plate 3, and a joint between the third side plate 3 and each of the second side plate 2 and the fourth side plate 4 is smoothly transitioned. The second side plate 2 and the third side plate 3 both includes a straight section 201 and an arc section 202, and the straight section 201 and the arc section 202 are in smooth transition connection. The structure can be adapted to different types of griddles 9, such as griddles 9 with inclined side surfaces or a combination of straight and arc-shaped side surfaces, which all can be adapted to the edge structure of the griddle cover of the disclosure.

The above is merely the specific implementations of the disclosure and is not intended to limit the scope of protection of the disclosure. Any variations or replacements apparent to a person skilled in the art within the technical scope disclosed by the disclosure shall fall within the scope of protection of the disclosure. Therefore, the scope of protection of the disclosure shall be subject to the scope of protection of the claims.

What is claimed is:

1. A griddle cover, comprising a bottom plate, wherein a first side plate and a third side plate are formed on front and rear sides of the bottom plate respectively, a second side plate and a fourth side plate are formed on left and right sides of the bottom plate respectively, the first side plate, the second side plate, the third side plate, and the fourth side plate are sequentially connected along a circumferential direction;
edges of the first side plate, the second side plate, the third side plate, and the fourth side plate are folded outward to form clamping grooves to be connected with edges of the baking pan; and
the griddle cover is further provided with a plurality of magnets to be attracted and connected to the baking pan.

2. The griddle cover according to claim 1, wherein the griddle cover is integrally formed by silica gel, and the magnets are wrapped in the silica gel.

3. The griddle cover according to claim 2, wherein the magnets are fixedly formed on the bottom plate.

4. The griddle cover according to claim 3, wherein the magnets are sequentially arranged along the circumferential direction of the bottom plate.

5. The griddle cover according to claim 2, wherein the magnets are fixedly formed on the first side plate, the second side plate, the third side plate, and the fourth side plate. The griddle cover according to claim 2, wherein the magnets are arranged on the bottom plate, the first side plate, the second side plate, the third side plate, and the fourth side plate respectively.

6. The griddle cover according to claim 1, wherein the magnets are circular, oval, or polygonal.

7. The griddle cover according to claim 1, wherein arc-shaped handles with holes are formed on the second side plate and the fourth side plate.

8. The griddle cover according to claim 1, wherein the bottom plate is provided with a plurality of raised stripes arranged in parallel.

9. The griddle cover according to claim 1, wherein heights of the first side plate, the second side plate, and the fourth side plate are greater than that of the third side plate, and a joint between the third side plate and each of the second side plate and the fourth side plate is smoothly transitioned.

10. The griddle cover according to claim 10, wherein the second side plate and the third side plate both comprises a straight section and an arc section, and the straight section and the arc section are in smooth transition connection.
